(19) United States
(12) Patent Application Publication
(10) Pub. No.: US 2014/0119034 A1
(43) Pub. Date: May 1, 2014

(54) INDUCTIVE ILLUMINATION APPARATUS

(71) Applicants: Ming-Yun Chen, Dong Guan City (CN); Zou-Cai Hong, Dong Guan City (CN)

(72) Inventors: Ming-Yun Chen, Dong Guan City (CN); Zou-Cai Hong, Dong Guan City (CN)

(21) Appl. No.: 14/126,370

(22) PCT Filed: Jun. 14, 2012
(86) PCT No.: PCT/CN2012/076930

§ 371 Date: Dec. 13, 2013

(30) Foreign Application Priority Data
Jun. 14, 2011 (CN) 201120199045.8
Jun. 14, 2011 (CN) 201120199410.5
Jun. 14, 2011 (CN) 201120199479.8
Jun. 14, 2011 (CN) 201120199481.5
Jun. 14, 2011 (CN) 201120199523.5

(51) Int. Cl. F21V 23/04

(52) U.S. Cl. CPC F21V 23/0471
USPC 362/373; 362/362

(57) ABSTRACT

The present invention relates to a inductive illumination apparatus. The inductive illumination apparatus includes a lamp body, a light emitting module, and a sensor and driver module. The light emitting module is disposed on the lamp body and electrically connected to the light emitting module. The light emitting module includes a first circuit board disposed with a plurality of light emitting components. The sensor and driver module includes a second circuit board disposed with a sensor device. The first circuit board has an opening. The second circuit board is disposed through the opening of the first circuit board so that the sensor device is surrounded by the light emitting components.

### FIELD OF INVENTION

The present invention relates to illumination technical field, and more particularly relates to an inductive illumination apparatus with sensor function.

### BACKGROUND

It is a global trend for governments of many countries to advocate policy of energy saving and carbon reducing. More and more light devices have power saving features. A common way is to dispose sensor devices on illumination apparatuses to detect people movement so that the illumination apparatuses may be turned on or turned off depending on whether users exist or not.

In conventional art, however, circuit boards occupy certain space and require certain structures and thus sensor devices usually need to be disposed in a peripheral side of illumination apparatuses. In such design, detection areas of sensor devices may have certain difference from illumination areas of light emitting modules or may be shielded by illumination apparatuses. For example, to ensure illumination areas of light emitting modules, detection areas of sensor devices may have bias offset. On the other hand, if to ensure detection areas of sensor devices, illumination areas of light emitting modules may have bias offset. In short, current illumination apparatuses with sensor devices need to be improved.

Besides, some manufacturers directly dispose sensor devices at center portions of illumination apparatuses, but such configuration may cause sensor devices being suffered from affection of light from light emitting modules and heat influence and consequently causes sensor devices failing to detect correctly. Moreover, current sensor devices and light emitting modules are welded on the same circuit boards. If one of the sensor device or the light emitting module is broken, even the other function normally, the illumination apparatus thereof cannot work. Broken parts cannot be replaced even other parts are normal. It is not favorable to environmental protection.

In light of this, the present invention provides an illumination apparatus which circuit board utilizes space well, which sensor device detects well, and which sensor device or light emitting module may be easily replaced, solving problems eager to be solved in this field.

### SUMMARY OF INVENTION

A major objective of the present invention is to provide an inductive illumination apparatus. By skillfully assembling a circuit board with light emitting diodes and a circuit board with a sensor device to optimize space use so that the sensor device is disposed near the center of the illumination apparatus while being surrounded by a plurality of light emitting components.

To achieve the above objective, an embodiment is an inductive illumination apparatus that includes a lamp body, a light emitting module disposed on the lamp body. The light emitting module includes a plurality of light emitting components and a first circuit board. These light emitting components are disposed on the first circuit board and the first circuit board has an opening. The inductive illumination apparatus also has a sensor and driver module electrically connected to the light emitting module. The driver and sensor module at least includes a second circuit board disposed with a sensor device. The second circuit board is disposed through the opening of the first circuit board so that the sensor device is surrounded by the light emitting components.

Preferably, the lamp body defines an accommodation space. The first circuit board is stacked on the lamp body so that the accommodation space of the lamp body is connected to the opening of the first circuit board of the light emitting module. When a portion of the second circuit board is accommodated in the accommodation space of the lamp body, another portion of the second circuit board is disposed through the opening of the first circuit board. The opening is formed near the center portion of the first circuit board.

Preferably, the second circuit board includes a sensor circuit board and a driver circuit board. The driver circuit board and the sensor circuit board are electrically connected. The sensor device is disposed on the sensor circuit board. The driver circuit board has two electrodes, a driver integrated circuit chip and a transformer.

Preferably, the sensor device is a passive infrared sensor (PIR) component.

Preferably, the sensor and driver module further includes a glare shield. The glare shield is connected to the first circuit board and covers the passive infrared sensor component of the second circuit board to separate the passive infrared sensor component from the light emitting components. The light emitting components are a plurality of LED light emitting components.

Preferably, the sensor and driver module further includes a lens. The lens is disposed at one end of the glare shield that is far away form the first circuit board so that there is a predetermined distance between the lens and the passive infrared sensor component covered in the glare shield.

Preferably, the inductive illumination apparatus further includes a transparent lamp shade. The transparent lamp shade covers the light emitting module and is connected to the lamp body.

Preferably, there is an opening hole on the top of the transparent lamp shade. At least one of the glare shield and the lens is disposed through the opening hole.

Preferably, the lamp body includes a lamp cup, a center sleeve and a lamp cap module. The center sleeve is disposed through the inner side of the lamp cup. The center sleeve has two opposite ends. One end of the center sleeve is connected to the lamp cap module and the other end of the center sleeve is connected to the first circuit board.

Preferably, the lamp cap module includes a lamp cap inner tube, a conductive outer casing and a conductive component. The conductive outer casing is sleeved to an outer surface of the lamp cap inner tube and the conductive component is plugged at the bottom side of the lamp cap inner tube.

Preferably, the lamp body further includes a first conductive pin and second conductive pin. The first ends of the first conductive pin and second conductive pins are respectively electrically connected to the two electrodes of the driver circuit board. The conductive outer casing is connected to the lamp cap inner tube. The second end of the first conductive pin is inserted to the gap between the conductive outer casing and the lamp cap inner tube so that the second end of the first conductive pin is electrically connected to the conductive outer casing.

Preferably, the lamp body further includes a first conductive pin and a second conductive pin. The first ends of the first conductive pin and the second conductive pin are respectively electrically connected to the two electrodes of the driver circuit board. The conductive component is disposed in a connection hole defined by the bottom of the lamp cap inner tube. At least a portion of the conductive component is exposed outside the lamp cap inner tube. The second end of the second conductive pin is inserted to the connection hole and electrically connected to the conductive component.

Preferably, the sensor device is a microwave sensor component.

Preferably, the inductive illumination apparatus further includes a transparent lamp shade. The transparent lamp shade covers the light emitting module and is connected to the lamp body.

Preferably, the lamp body includes a lamp cup, a center sleeve and a lamp cap module. The center sleeve is disposed through the inner side of the lamp cup. The center sleeve has two ends. One end of the center sleeve is connected to the lamp cap module. Another end of the center sleeve is connected to the first circuit board.

Preferably, the microwave sensor component includes a upper cover casing, an antenna module, an amplifying circuit board and a bottom cover casing. The antenna module and the amplifying circuit board are clipped and disposed between the upper cover casing and the bottom cover casing. The antenna module and the amplifying circuit board are connected to each other.

Preferably, the lamp cap module includes a lamp cap inner tube, a conductive outer casing and a conductive component. The conductive outer casing is sleeved to outer surface of the lamp cap inner tube. The conductive component is plugged to the bottom of the lamp cap inner tube.

Preferably, the lamp body further includes a first conductive pin and second conductive pin. The first ends of the first conductive pin and the second conductive pin are respectively electrically connected to the two electrodes of the driver circuit board. The conductive outer casing is screwed to the lamp cap inner tube. The second end of the first conductive pin is inserted to the gap between the conductive outer casing and the lamp cap inner tube so that the second end of the first conductive pin is electrically connected to the conductive outer casing.

Preferably, the lamp body further includes a first conductive pin and a second conductive pin. The first ends of the first conductive pin and the second conductive pin are respectively electrically connected to the two electrodes of the driver circuit board. The conductive component is disposed in a connection hole defined by the bottom of the lamp cap inner tube. At least a portion of the conductive component is exposed outside the lamp cap inner tube so that the second end of the second conductive pin is inserted to the connection hole and electrically connected to the conductive component.

Preferably, the lamp body includes an alloy cooling fins of high thermal conductivity. The first circuit board is disposed on the alloy cooling fins of high thermal conductivity of the lamp body.

Preferably, the first circuit board of the light emitting module has a height near center portion larger than a height near edge portion.

Another preferred embodiment is to provide a inductive illumination apparatus. The inductive illumination apparatus includes a lamp body and a light emitting module disposed on the lamp body. The light emitting module includes a plurality of light emitting components and a first circuit board. The light emitting components are disposed on the first circuit board. The first circuit board has an annular opening. The inductive illumination apparatus further includes a sensor and driver module electrically connected to the light emitting module. The sensor and driver module at least includes a second circuit board that has a passive infrared sensor component. The second circuit board is disposed through the annular opening of the first circuit board so that the sensor device is surrounded by the light emitting components.

The accommodation space of the lamp body is connected to the annular opening of the first circuit board of the light emitting module. When a portion of the second circuit board is accommodated in the accommodation space of the lamp body, another portion of the second circuit board is disposed through the annular opening of the first circuit board of the light emitting module. The annular opening is formed near center portion of the first circuit board.

Preferably, the sensor and driver module further includes a glare shield. The glare shield is connected to the first circuit board and covers the passive infrared sensor component of the second circuit board. The light emitting modules are a plurality of LED light emitting components.

Preferably, the sensor and driver module further includes a lens. The lens is disposed at an end of the glare shield away from the first circuit board so that there is a predetermined distance between the lens and the passive infrared sensor component covered in the glare shield.

Preferably, the inductive illumination apparatus further includes a transparent lamp shade. The transparent lamp shade covers the light emitting module and connected to the lamp body. The top of the transparent lamp shade has an opening hole. At least one of the glare shield and the lens is disposed through the opening hole.

Another preferred embodiment according to the present invention is a inductive illumination apparatus. The inductive illumination apparatus includes a lamp body and a light emitting module disposed on the lamp body. The light emitting module includes a plurality of light emitting components and a first circuit board. The light emitting components are disposed on the first circuit board and the first circuit board has an annular opening. The inductive illumination apparatus further includes a sensor and driver module electrically connected to the light emitting module. The sensor and driver module at least includes a second circuit board that has a microwave sensor device. The second circuit board is disposed through the annular opening of the first circuit board so that the sensor device is surrounded by the light emitting components.

Preferably, the lamp body defines an accommodation space and the accommodation space is connected to the annular opening of the first circuit board of the light emitting module. When a portion of the second circuit board is accommodated in the accommodation space of the lamp body, another portion of the second circuit board is disposed through the annular opening of the first circuit board of the first light emitting module. The annular opening is formed near the center portion of the first circuit board.

Preferably, the microwave component includes an upper cover casing, an antenna module, an amplifying circuit board and a bottom cover casing. The antenna module and the amplifying circuit board are clipped between the upper cover casing and the bottom cover casing. The antenna module and the amplifying circuit board are connected to each other.

Another preferred embodiment is to provide an inductive illumination apparatus. The inductive illumination apparatus includes a lamp body and a light emitting module disposed on the lamp body. The light emitting module includes a plurality of light emitting components and a first circuit board. The light emitting components are disposed on the first circuit board. The inductive illumination apparatus further includes a sensor module electrically connected to the light emitting module. The sensor module includes a sensor device and a second circuit other than the first circuit board. The sensor device is disposed on the second circuit board. The second circuit board of the sensor module is assembled near center portion of the first circuit board of the light emitting module so that the sensor device is surrounded by the light emitting components.

Preferably, the second circuit board includes a sensor circuit board and a driver circuit board. The driver circuit board and the sensor circuit board are electrically connected. The sensor device is disposed on the sensor circuit board. The driver circuit board includes two electrodes, a driver integrated circuit chip and a transformer.

Preferably, the sensor module is one of a passive infrared sensor component and a microwave sensor component.

Preferably, the lamp body further includes a heat dissipation block. The heat dissipation block directly props to the driver integrated circuit chip and/or the transformer.

Preferably, the lamp body further includes a heat dissipation block and a silicon gasket. The silicon gasket is disposed between the heat dissipation block and the driver integrated circuit chip of the driver circuit board. Alternatively, the silicon gasket is disposed between the heat dissipation block and the transformer.

Preferably, the lamp body further includes an alloy cooling fins of high thermal conductivity and an aluminum heat dissipation device. A surface of the alloy cooling fins is connected to the aluminum heat dissipation device. The other surface of the alloy cooling fins is an installation surface for installing the first circuit board.

The sensor device and the light emitting components of the inductive illumination apparatus of the present invention are separately disposed on at least two circuit boards. By arranging the two circuit boards skillfully and fully utilizing its inner space, the sensor device is surrounded by a plurality of light emitting components to provide uniform illumination. Moreover, the sensor device is protected by the glare shield to keep good detection capability.

### BRIEF DESCRIPTION OF DRAWINGS

FIG. 1 is a perspective view of a first embodiment of the inductive illumination apparatus of the present invention;

FIG. 2 is an exploded view of the first embodiment of the inductive illumination apparatus of the present invention;

FIG. 3 is an assembly portion of the first embodiment of the inductive illumination apparatus of the present invention;

FIG. 4 is a section view of the first embodiment of the inductive illumination apparatus of the present invention;

FIG. 5 is a perspective view of a second embodiment of the inductive illumination apparatus of the present invention;

FIG. 6 is a section view of the second embodiment of the inductive illumination apparatus of the present invention;

FIG. 7 is an exploded view of the second embodiment of the inductive illumination apparatus of the present invention; and

FIG. 8 is an exploded view of a third embodiment of the inductive illumination apparatus of the present invention;

### DETAILED DESCRIPTION

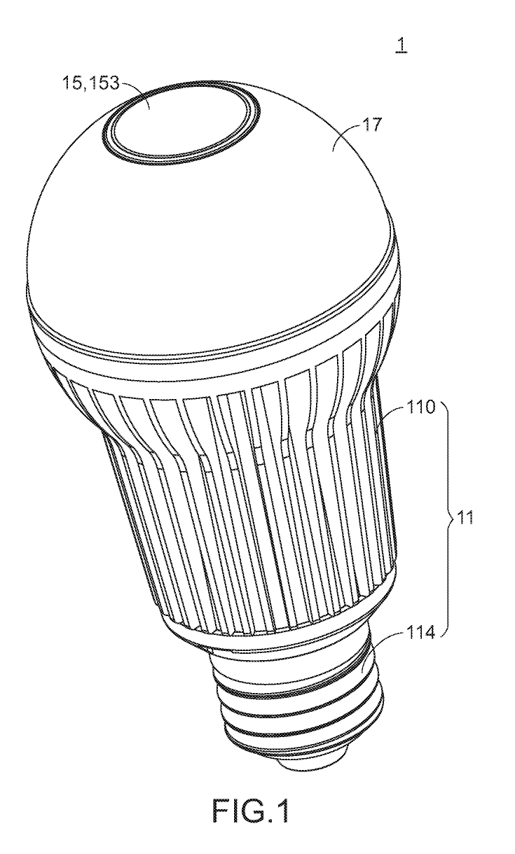

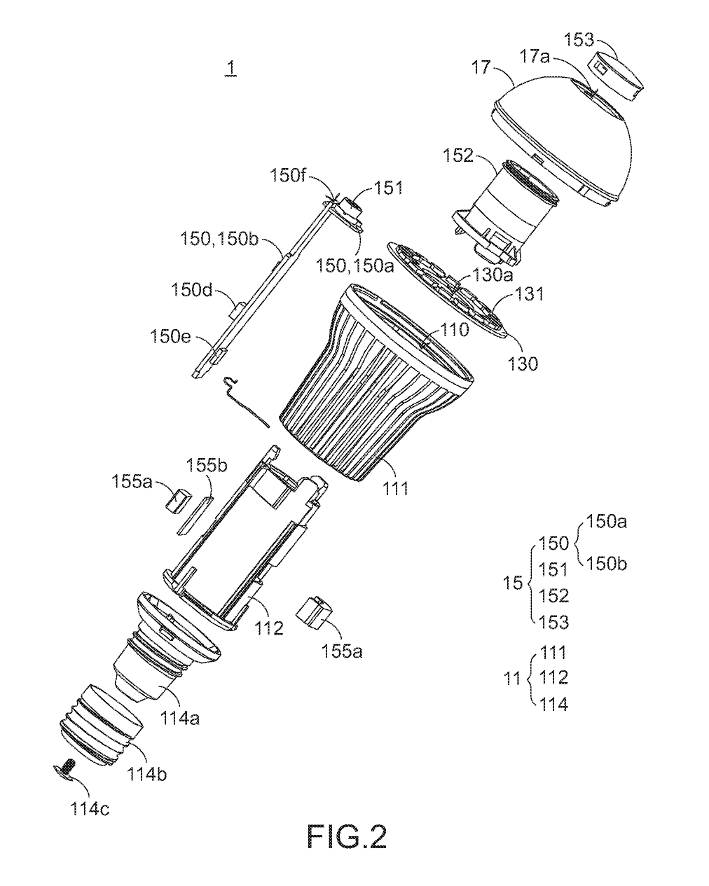

Please refer to FIGS. 1 and 2. FIG. 1 is a perspective view of a first embodiment of the inductive illumination apparatus of the present invention. FIG. 2 is an exploded view of the first embodiment of the inductive illumination apparatus of the present invention.

The inductive illumination apparatus 1 of the present invention includes a lamp body 11, a light emitting module 13 and a sensor and driver module 15. The light emitting module 13 and the sensor and driver module 15 are disposed on the lamp body 11. The light emitting module 13 is electrically connected to the sensor and driver module 15. In a preferred embodiment, the light emitting module 13 and the sensor and driver module 15 are welded with electrical lines or electrically connected with electrical connection terminals (not shown). In addition, the light emitting module 13 includes a first circuit board 130 with a plurality of light emitting components 131. The sensor and driver module 15 at least includes a second circuit board 150 disposed with a sensor device 151. These light emitting components 131 are LED light emitting components. With such design, the light emitting components 131 are capable of detecting whether human movement is existed by the sensor device 151 and performs corresponding response of turn-on or turn-off.

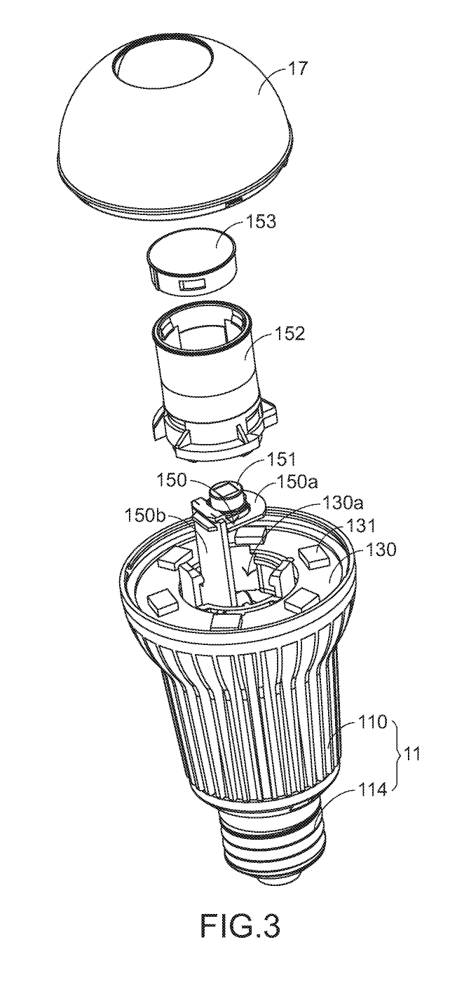

FIG. 3 is an assembly portion of the first embodiment of the inductive illumination apparatus of the present invention. Please also refer to FIGS. 2 and 3. The first circuit board 130 has an opening 130a for the second circuit board to be disposed through the opening. Besides, the first circuit board may be an annual circuit board and the annual circuit board defines an opening 130 as an annual hole. Alternatively, the first circuit board 130 may be an U shape circuit board (not shown), and the U shape circuit board defines an opening 130a as an open opening. It is to be noted that the opening 130a defined by the first circuit board 130 may have various shapes and the present invention is not limited to illustrated shapes.

With such design, the spatial problem among multiple circuit boards is solved and thus the size of the circuit boards is not limited accordingly. As such, utilization of space is increased dramatically so that components may have more flexible arrangement.

As mentioned above, because the spatial structure limitation of the circuit board is unblocked, the sensor device is not necessary to be disposed at peripheral portion of the inductive illumination apparatus 1 as in conventional art. The sensor device 151 may be disposed near the center of the inductive illumination apparatus 1 to ensure the detection range of the sensor device 151 heads to same direction as the illumination range of the light emitting components 131.

If there is no spatial block problem among circuit boards, the structure of the first circuit board 130 may be a solid plate (not shown). The second circuit board 150 disposed with the sensor device may be assembled to the first circuit board 130 via an electrical interface (not shown) and form a two-layers stack structure circuit module (not shown). Preferably, the second circuit board 150 may be disposed near the center of the first circuit board 130. Such design, however, is an example but not a limitation to the present invention.

Moreover, because the light emitting components 131 are disposed around the sensor device 151 to provide a surrounding 360 degrees illumination, the sensor device 151 does not shield the light emitting components 131 in certain direction and does not decrease illumination efficiency of the inductive illumination apparatus 1.

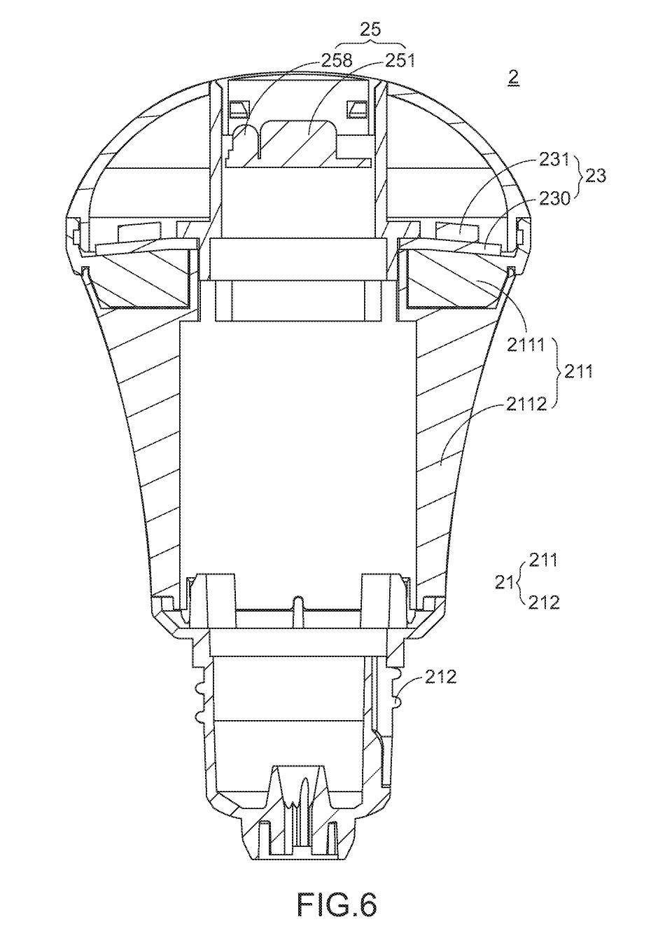

Besides, the first circuit board 130 may be made such that the height of the first circuit board 130 near the center is larger than the height thereof near the edge portion. Such design is increasing the illumination angle of the light emitting components 131, so as to increase illumination brightness. This is also an option to implement the present invention. Please refer FIG. 6 and following description.

Please refer to FIG. 2 again, because the opening 130a of the first circuit board 130 is more close to the center portion and the first circuit board 130 is stacked upon the lamp body 11 so that the opening 130a is connected to a accommodation space 110 of the lamp body 11. With such design, a portion of the second circuit board 150 is accommodated in the accommodation space 110 of the lamp body 11. Another portion of the second circuit board 150 is disposed through the opening 130a of the first circuit board 130 of the light emitting module 13.

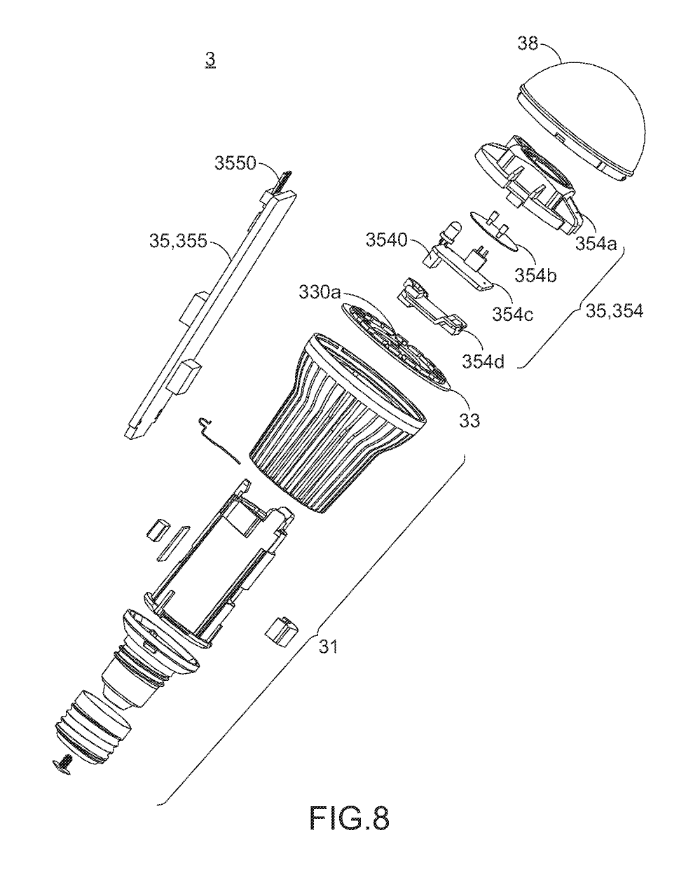

In the following description, two different sensor devices are explained as embodiments. In the embodiment using the first sensor device, the sensor device 151 of the sensor and driver module 15 is a passive infrared sensor component. In the embodiment using the second sensor device, the sensor device 154 of the sensor and driver module 15 is a microwave sensor component. Please refer to FIG. 8 and following description.

In the first embodiment, the lamp body 11 further includes a lamp cup 111, a center sleeve 112 and a lamp cap module 114. The accommodation space 110 is defined by an inner edge surface by the lamp cup 111. The center sleeve 112 is disposed through the internal side of the lamp cup. The second circuit is then disposed in the inner side of the center sleeve 112. The center sleeve 112 has two opposite ends. One end of the center sleeve 112 is connected to the lamp cap module 114. The other end of the center sleeve 112 is connected to bottom of the first circuit board 130.

The sensor and driver module 15 further includes a glare shield 152 disposed in the other side of the first circuit board with respect to the center sleeve 112. The glare shield 152 shields the passive infrared sensor component to separate the passive infrared sensor component form the light emitting component 131 to prevent the passive infrared sensor component interfered by light or heat. Please also be noted that persons of ordinary skilled in the art may modify above design to clip the glare shield 152 and the center sleeve 112. Thus, the connection position between the glare shield 152 and the center sleeve 112 is not limited to certain configuration.

Specifically, the sensor and driver module may further include a lens 153. The lens 153 is disposed at the end of the glare shield away form the first circuit board so that when the lends 153 is connected to the glare shield 152, the lens 153 has a predetermined distance from the passive infrared sensor component 151 in the glare shield 152. The distance between the lens 153 and the passive infrared sensor component 151 is a factor to determine detection accuracy of the passive infrared sensor component 151. Therefore, positioning via structures may keep the lens 153 and the infrared sensor component 151 in an optimum distance. Therefore, with the design of the present invention, the passive infrared sensor component 151 may be kept at optimum position and height and are not affected by human assembling, causing uncertain variation.

Besides, the inductive illumination apparatus 1 includes a transparent shade 17. The transparent lamp shade 17 shields the light emitting module 13 and is coupled to the lamp body 11. In response to the glare shield 152, the transparent lamp shade 17 has an opening hole 17a at top. In addition, one of the glare shield 152 and the lens 153 is disposed through or aligning with the opening hole 17a to obtain better detection view.

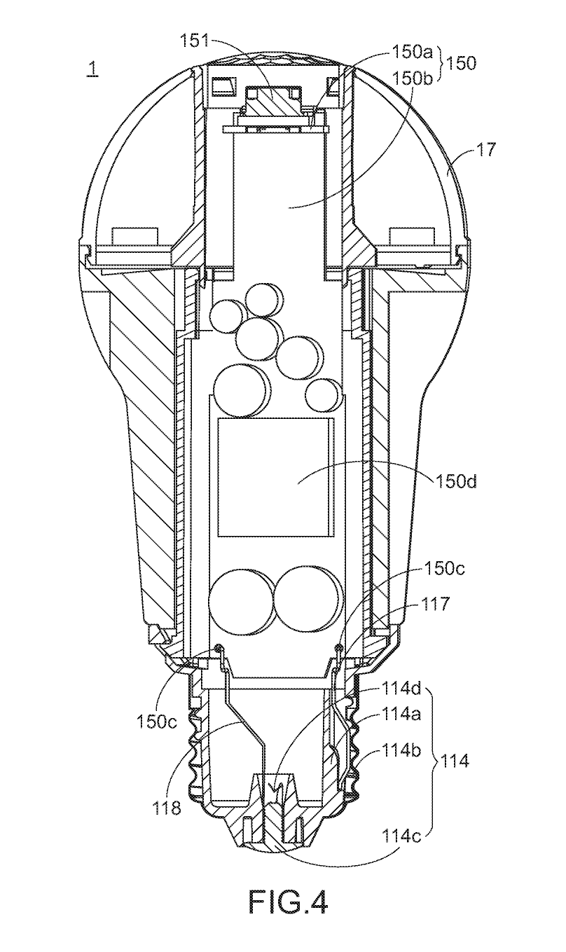

FIG. 4 is a section view of the first embodiment of the inductive illumination apparatus of the present invention. Please also refer to FIG. 2 and FIG. 3. The second circuit board 150 includes a sensor circuit board 150a and a driver circuit board 150b. The sensor circuit board 150a is assembled to the assembling portion 150f of the driver circuit board 150b and is electrically connected to the driver circuit board 150b. Preferably, the sensor circuit board 150a and the driver circuit board 150b are perpendicularly disposed so that the detection direction of the sensor device 1501 disposed on the sensor circuit board 150a is parallel to the containing direction of the driver circuit board to facilitate being stored and positioned.

In addition, the driver circuit board 150b includes two electrodes 150c, a driver integrated circuit chip 150d and a transformer 150e. In addition, the lamp body 11 further includes a heat dissipation block 155a. The heat dissipation block 155a may directly contact one of the driver integrated circuit chip 150d or the transformer 150e. Alternatively, the heat dissipation block 155a may indirectly contact at least one of the driver integrated circuit chip 150d or the transformer 150e. By the flexible characteristic and good thermal conductivity of the silicon gasket 155b, the silicon gasket 155b is attached to at least one of the driver integrated circuit chip 150d and the transformer 150e to facilitate heat dissipation.

In this embodiment, the lamp cap module 114 includes a lamp cap inner tube 114a, a conductive outer casing 114b and a conductive component 114c. The conductive outer casing 114b is sleeved on an outer surface of the lamp cap inner tube 114a, and the conductive component 114c is plugged in the bottom surface of the lamp cap inner tube 114a. The lamp cap inner tube 114a is made of insulation material. After the conductive casing 114b and the conductive component 114c are respectively connected to the lamp cap inner tube 114a, the conductive outer casing 114b and the conductive component 114c may serve as two electrode connecting points to a power source.

Moreover, the lamp body 11 further includes a first conductive pin 117 and a second conductive pin 118. The first ends of the first conductive pin 117 and the second conductive pin 118 are respectively connected to the two electrodes 150c of the driver circuit board 150b.

Next, the following description explains the second ends of the first conductive pin 117 and the second conductive pin 118. The conductive outer casing 114b is sleeved to the lamp cap inner tube 114a. That is, the conductive outer casing 114b serves as an electrical connecting point. When the second end of the first conductive pin 117 is inserted to the crevice between the conductive outer casing 114b and the lamp cap inner tube 114, the second end of the first conductive pin 117 is electrically connected to the conductive outer casing 114b.

In addition, the conductive component 114c is disposed through a connection hole 114d defined by the bottom of the lamp cap inner tube 114a, so that at least a portion of the conductive component 114c is exposed outside the lamp cap inner tube 114a to serve as another electrical connecting point. Therefore, the second end of the second conductive pin 118 is plugged into the connection hole 114d to be electrically connected to the conductive component 114c.

With the above configuration, the first conductive pin 117 and the second conductive pin 118 are propped respectively to the conductive outer casing 114b and the conductive component 114c to perform electrical connection. It is easier to be assembled without welding tools. The efficiency of production is achieved and even further cost down.

It is to be understood that the invention needs not to be limited to the disclosed embodiments. On the contrary, any alternative way to achieve electrical connection between the driver circuit board 150b to the conductive outer casing 114b and the conductive component 114c may be used.

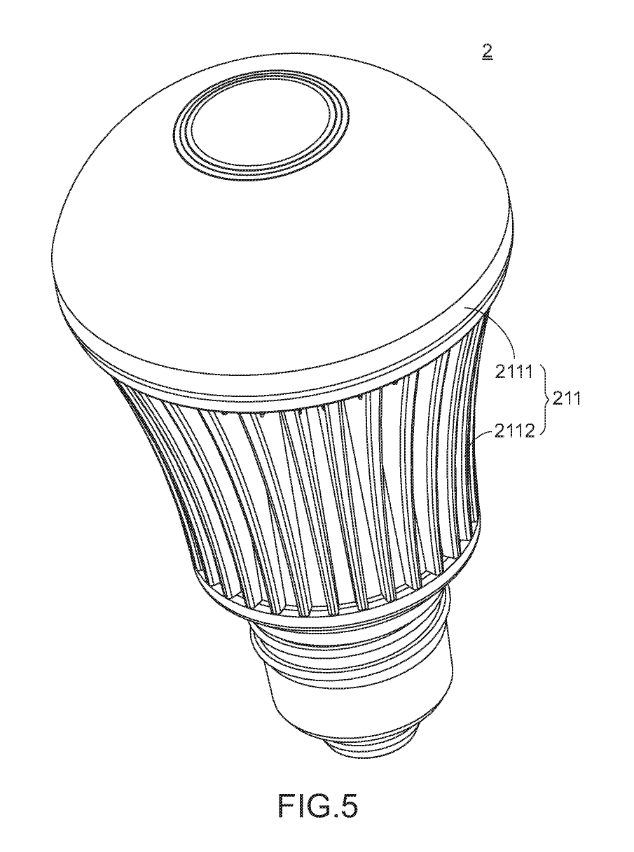

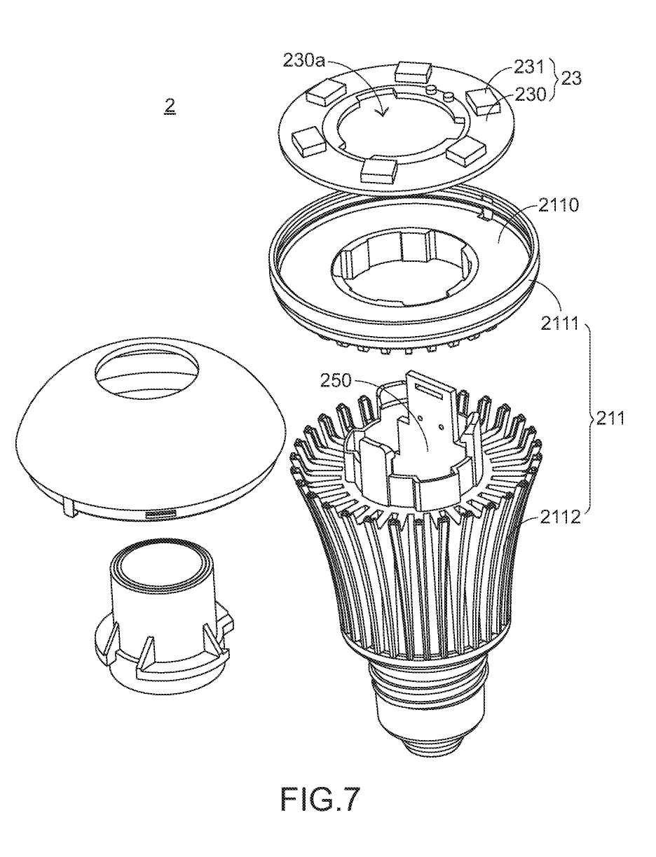

FIG. 5 is a perspective view of a second embodiment of the inductive illumination apparatus of the present invention. FIG. 6 is a section view of the second embodiment of the inductive illumination apparatus of the present invention and FIG. 7 is an exploded view of the second embodiment of the inductive illumination apparatus of the present invention.

Firstly, please refer to FIG. 6. In this embodiment, the inductive illumination apparatus 2 includes a lamp body 21, a light emitting module 23, a sensor and driver module 25. The height near the center portion of the first circuit board 230 of the light emitting module 23 is larger than the height near the edge portion of the first circuit board 230 of the light emitting module 23. Preferably, the first circuit board 230 takes an angle of 5 degrees tilt to rise from the edge portion to the center portion so that a plurality of light emitting components 231 disposed on the first circuit board 230 have larger joint illumination angle to obtain optimum illumination range and brightness.

The lamp body 21 includes a lamp cup 211 and a lamp cap module 212. The lamp cup includes an alloy cooling fin 2111 and an aluminum heat dissipation device 2112. The alloy cooling fin 2111 is connected to and disposed on the top of the aluminum heat dissipation device 2112. The aluminum heat dissipation device 2112 has a shape of radial fins to achieve high heat dissipation effect. Moreover, an installation surface 2110 is formed on a surface other than the surface that the alloy cooling fins faces the aluminum heat dissipation device 2112. In addition, the first circuit board 230 is installed on the installation surface 2110. With such configuration, heat generated by the first circuit board 230 may be dissipated by heat conduction.

Please be noted that the alloy cooling fins 2111 and the aluminum heat dissipation device 2112 may be formed as intergraded structure, or implemented by assembling as described in above embodiment. Preferably, the alloy cooling fins 2111 may be an aluminum alloy cooling fins made of aluminum alloy material, a magnesium-lithium alloy cooling fins made of magnesium-lithium material, an aluminum magnesium cooling fins made of aluminum magnesium material, or made of any other alloy material with high thermal conductivity.

In addition, in this embodiment, the sensor and driver module 25 includes a sensor device 251, a light transducer 258 and a second circuit board 250. The sensor device 251 and the light transducer 258 are together disposed on the second circuit board 250. In this embodiment, the transducer 258 is disposed neighboring to the sensor device 251. The light transducer 258 is used for detecting ambient light so as to control the light emitting module 23 to supplement illumination in low light condition. Similar to the first embodiment, the first circuit board 230 has an opening 230a. The second circuit board 250 is disposed through the opening 230a of the first circuit board 230 so as to prevent mutual seizing and achieve maximum space utilization.

FIG. 8 is an exploded view of a third embodiment of the inductive illumination apparatus of the present invention. In the third embodiment, the inductive illumination apparatus 3 includes a lamp body 31, a light emitting module 33, a sensor and driver module 35, and a transparent lamp shade 38. The structures and functions of the lamp body 31 and the light emitting module 33 are similar to those described in previous two embodiments and are not redundantly described herein.

Please be noted that the sensor and driver module 35 includes a sensor device 354 and a second circuit board 355. Similar to the previous two embodiments, the second circuit board 355 is disposed through an opening 330a defined by the light emitting module 33. Unlike the first and second embodiments, the second circuit board 355 of the third embodiment is a driver circuit board, and the sensor device 354 is a microwave sensor component. The characteristics of microwave detection and infrared detection are different. In the first and second embodiments, a passive infrared sensor component needs a glare shield 152 to be separated from the light emitting components 131, but it is not needed for microwave sensor components. Therefore, the third embodiment does not equip with glare shield and components like lens. Further, the transparent lamp shade 38 has a complete arc shape without an opening therein.

Please be also noted that the microwave component includes an upper cover casing 354a, an antenna module 354b, an amplifying circuit board 354c and a bottom cover casing 354d. The antenna module 354b and the amplifying circuit board 354c are clipped and disposed between the upper cover casing 354a and the bottom cover casing 354d. The antenna module 354b and the amplifying circuit board 354c are connected to each other.

Please be also noted that preferable way for connecting the first circuit board 354c and the second circuit board 355 is described as following. The amplifying circuit board 354c has an anode plug head 3540. The second circuit board 355 has a cathode plug socket 3550. The anode plug head 3540 and the cathode plug socket 4550 match each other so that the amplifying circuit board 354c and the second circuit board 355 are electrically connected. Other connection like clip connection or welding may also be applied and are under the scope of the present invention.

With such configuration, according to the sensor result of determining whether human movement is existed by the microwave sensor component may control lights to be turned on or off, so as to achieve energy saving.

In summary, sensor devices and light illumination components are separately disposed on at least two circuit boards in the inductive illumination apparatuses of the present invention. By arranging the at least two circuit boards and improving using internal space, the sensor devices are surrounded by a plurality of light emitting components so as to provide uniform illumination while the sensor devices are protected by the glare shields to keep good detection capability.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. An inductive illumination apparatus, comprising:
a lamp body;
a light emitting module disposed on the lamp body, the light emitting module comprising a plurality of light emitting components and a first circuit board, the light emitting components being disposed on the first circuit board, and the first circuit board having an opening;
a sensor and driver module electrically connected to the light emitting module, the sensor and driver module further comprising a second circuit board with a sensor device disposed thereon;
wherein the second circuit board is disposed through the opening of the first circuit board so that the sensor device is surrounded by the light emitting components.

2. The inductive illumination apparatus of claim 1, wherein the lamp body has a accommodation space, and the first circuit board is stacked on the lamp body so that the accommodation space is connected to the opening of the first circuit board of the light emitting module, when a portion of the second circuit board is accommodated in the accommodation space of the lamp body, another portion of the second circuit board is penetrating through the opening of the first circuit board of the light emitting module, wherein the opening is formed near the center of the first circuit board.

3. The inductive illumination apparatus of claim 2, wherein the second circuit board comprises a sensor circuit board and a driver circuit board, the driver circuit board and the sensor circuit board are electrically connected; wherein the sensor device is disposed on the sensor circuit board, and the driver circuit board comprises two electrodes, a driver integrated circuit chip and a transformer.

4. (canceled)

5. (canceled)

6. (canceled)

7. (canceled)

8. (canceled)

9. The inductive illumination apparatus of claim 3, further comprising a transparent lamp shade, the transparent lamp shade covering the light emitting module and being connected to the lamp body, wherein the lamp body comprises a lamp cup, a center sleeve and a lamp cap module, and the center sleeve is disposed through inner side of the lamp cup; wherein the center sleeve has two opposite ends, one end of the center sleeve is connected to the lamp cap module, and the other end of the center sleeve is connected to the first circuit board.

10. The inductive illumination apparatus of claim 9, wherein the lamp cap module comprises a lamp cap inner tube, a conductive outer casing and a conductive component, the conductive casing is sleeved to an outer surface of the lamp cap inner tube and the conductive component is plugged in a bottom surface of the lamp cap inner tube.

11. The inductive illumination apparatus of claim 10, wherein the lamp body further comprises a first conductive pin and a second conductive pin, first ends of the first conductive pin and the second conductive pin are respectively connected to the two electrodes of the driver circuit board; wherein the conductive outer casing is connected to the lamp cap inner tube, the second end of the first conductive pin is inserted into a gap between the conductive outer casing and the lamp cap inner tube so that the second end of the first conductive pin is electrically connected to the conductive outer casing or wherein the lamp body further comprises a first conductive pin and a second conductive pin, the first ends of the first conductive pin and the second conductive pin are respectively connected to the two electrodes of the driver circuit board; wherein the conductive component is disposed in a connection hole defined by the bottom of the lamp cap inner tube, the conductive component has at least a portion exposed outside the lamp cap inner tube, and the second end of the second conductive pin is plugged in the connection hole and electrically connected to the conductive component.

12. (canceled)

13. The inductive illumination apparatus of claim 3, wherein the sensor device is a passive infrared sensor component wherein the sensor and driver module further comprises a glare shield, the glare shield is connected to the first circuit board and covering the passive infrared sensor component of the second circuit board to separate the passive infrared sensor component from the light emitting components; wherein the light emitting sensor components are a plurality of LED light emitting components.

14. (canceled)

15. The inductive illumination apparatus of claim 13, wherein the sensor and driver module further comprises a lens, the lens is disposed at an end of the glare shield away from the first circuit board so that there is a predetermined distance between the lens and the passive infrared sensor component covered in the glare shield, wherein an opening hole is formed at top of the transparent lamp shade, and at least one of the lamp shade and the lens is disposed through the opening hole.

16. The inductive illumination apparatus of claim 3, wherein the sensor device is a microwave sensor component, wherein the microwave sensor component comprises a upper cover casing, an antenna module, an amplifying circuit board and a bottom cover casing; wherein the antenna module and the amplifying circuit board are clipped between the upper cover casing and the bottom cover casing, and the antenna module and the amplifying circuit board are coupled to each other.

17. (canceled)

18. (canceled)

19. (canceled)

20. The inductive illumination apparatus of claim 1, wherein the lamp body comprises an alloy cooling fins with high thermal conductivity; or wherein the height of the vicinity of the center portion of the first circuit board is higher than the height of the vicinity of the edge portion of the first circuit board of the light emitting module.

21. (canceled)

22. An inductive illumination apparatus, comprising:
a lamp body;
a light emitting module disposed on the lamp body, the light emitting module comprising a plurality of light emitting components and a first circuit board, the light emitting components disposed on the first circuit board, and the first circuit board having an annular opening; and
a sensor and driver module electrically connected to the light emitting module, the sensor and driver module at least comprising a second circuit board, the second circuit board having a passive infrared sensor component;
wherein the second circuit board is disposed through the annular opening of the first circuit board so that the sensor and driver module is surrounded by the light emitting components.

23. The inductive illumination apparatus of claim 22, wherein the lamp body defines a accommodation space, the accommodation space is connected to the annular opening of the first circuit board of the light emitting module, so that when a portion of the second circuit board is accommodated in the accommodation space of the lamp body, another portion of the second circuit board is disposed through the annular opening of the first circuit board of the light emitting module, wherein the annular opening is formed near the center portion of the first circuit board.

24. The inductive illumination apparatus of claim 23, wherein the sensor and drive module further comprise a glare shield, the glare shield is coupled to the first circuit board and covering the passive infrared sensor component of the second circuit board to separate the passive infrared sensor component and the light emitting components, wherein the light emitting components are a plurality of LED light emitting components.

25. The inductive illumination apparatus of claim 24, wherein the sensor and driver module further comprises a lens, the lens is disposed at one end of the glare shield away from the first circuit board so that there is a predetermined distance between the lens and the passive infrared sensor component covered in the glare shield and the inductive illumination apparatus further comprises a transparent lamp shade covering the light emitting module and connected to the lamp body, wherein the top of the transparent lamp shade is formed with an opening hole, and at least one of the glare shield and the lens is disposed through the opening hole.

26. (canceled)

27. An inductive illumination apparatus, comprising:
a lamp body;
a light emitting module disposed on the lamp body, the light emitting module comprising a plurality of light emitting components and a first circuit board, the light emitting components being disposed on the first circuit board, and the first circuit board having an annular opening; and
a sensor and driver module electrically connected to the light emitting module, the sensor and driver module at least comprising a second circuit board, the second circuit board having a microwave sensor component;
wherein the second circuit board is disposed through the annular opening of the first circuit board so that the sensor device is surrounded by the light emitting components.

28. The inductive illumination apparatus of claim 27, wherein the lamp body defines a accommodation space, the accommodation space of the lamp body is connected to the annular opening of the first circuit board of the light emitting module so that when a portion of the second circuit board is accommodated in the accommodation space of the lamp body, another portion of the second circuit board is disposed through the annular opening of the first circuit board; wherein the annular opening is formed near the center portion of the first circuit board.

29. The inductive illumination apparatus of claim 28, wherein the microwave sensor component comprises an upper cover casing, an antenna module, an amplifying circuit board and a bottom cover casing, wherein the antenna module and the amplifying circuit board are clipped between the upper cover casing and the bottom cover casing and the antenna module and the amplifying circuit board are connected to each other.

30. An inductive illumination apparatus comprising:
a lamp body;
a light emitting module disposed on the lamp body, the light emitting module comprising a plurality of light emitting components and a first circuit board, the light emitting components being disposed on the first circuit board; and
a sensor module electrically connected to the light emitting module, the sensor module comprising a sensor device and a second circuit board other than the first circuit board, and the sensor device being disposed on the second circuit board;
wherein the second circuit board of the sensor module is assembled near the center of the first circuit board of the light emitting module so that the sensor device is surrounded by the light emitting components.

31. The inductive illumination apparatus of claim 30, wherein the second circuit board comprises a sensor circuit board and a driver circuit board, and the driver circuit board and the sensor circuit board are electrically connected; wherein the sensor device is disposed on the sensor circuit board, the sensor module is one of a passive infrared sensor component and a microwave sensor component, and the driver circuit board comprises two electrodes, a driver integrated circuit chip and a transformer.

32. (canceled)

33. The inductive illumination apparatus of claim 30, wherein the lamp body further comprises a heat dissipation block, and the heat dissipation block is directly contacting the integrated circuit chip and/or the transformer or wherein the lamp body further comprises a heat dissipation block and a silicon gasket, the silicon gasket is disposed between the heat dissipation block and the driver integrated circuit chip of the driver circuit board, and/or the silicon gasket is disposed between the heat dissipation block and the transformer or wherein the lamp body further comprises an alloy cooling fins with high thermal conductivity and an aluminum heat dissipation device, wherein one side of the alloy cooling fins is connected to the aluminum heat dissipation device and the other side of the alloy cooling fins is an installation surface for being disposed thereon by the first circuit board.

34. (canceled)

35. (canceled)
